(19) United States
(12) Patent Application Publication
(10) Pub. No.: US 2007/0119170 A1
(43) Pub. Date: May 31, 2007

(54) Non-rotating turbocharger waste gate valve

(76) Inventors: Patrick Masson, Urimenil (FR); Arnaud Gerrard, Epinal (FR); Thierry Palamar, Marange Silvange (FR); Laurent Valerie, Tendon (FR); Eduardo Massart, Igney (FR)

Correspondence Address: HONEYWELL TURBO TECHNOLOGIES, 23326 HAWTHORNE BOULEVARD, SUITE #200, TORRANCE, CA, 90505, US

(21) Appl. No.: 11/289,216

(22) Filed: Nov. 29, 2005

(51) Int. Cl. F02D 23/00; F02B 33/44

(52) U.S. Cl. 60/600; 60/602; 60/605.1

(57) ABSTRACT

A non-rotating turbocharger waste gate valve (130) for use in gasoline, diesel or other internal combustion engines. The cross section of the shaft (120) of valve (130) is oblong or otherwise non-circular, thus preventing rotation of valve (130) even under high load conditions. The elimination of valve rotation greatly reduces valve wear and increases the useful life of valve (130).

### BACKGROUND OF THE INVENTION

1. Field of the Invention (Technical Field)

The present invention relates to waste gate valves for turbochargers used in internal combustion engines.

2. Backqround Art

A turbocharger is an exhaust-driven blower that forces air into the engine under pressure. Turbochargers are used on gasoline and diesel engines to increase power output, while often improving engine efficiency (fuel economy and emissions levels). FIG. 1 shows a typical turbocharger. The maximum amount of boost pressure produced by the turbocharger is controlled by waste gate 200, which comprises a channel extending between inlet 270 from the engine's exhaust manifold and turbocharger outlet 210. When waste gate valve 230 is opened, the exhaust gasses, which enter turbocharger via inlet 270 and are normally routed directly to the exhaust turbine located in turbine housing 240, at least partially bypass the exhaust turbine, thus reducing the boost pressure. The further the waste gate is opened, the more exhaust bypasses the turbine, thereby further decreasing the boost. Under partial load, the waste gate is typically closed and the system routes all of the exhaust gases directly into turbine housing 240. Gases introduced into turbine housing 240 exit the housing via opening 220 and then proceed to the exhaust system via turbocharger outlet 210. Without a waste gate, the boost pressure produced by the turbocharger could exceed the maximum allowable combustion chamber pressure. This could lead to misfiring and engine damage.

The waste gate is typically operated by a diaphragm assembly 250. The actuator diaphragm is typically connected to the intake manifold, typically via a vacuum hose connected to fitting 255. A spring in the assembly typically keeps the waste gate closed at lower intake manifold pressures. As pressure builds up in the manifold over a preset value, the diaphragm compresses the spring, which is typically connected to waste gate valve 230 via linkage 260, thus partially or fully opening the waste gate. This redirects the flow of a portion of the exhaust gas from the turbocharger into the waste gate passage and out into the exhaust system via outlet 210, thereby reducing the boost pressure. The waste gate may alternatively be actuated electronically, or by other mechanical means, in response to one or more desired parameters other than, or in addition to, the intake manifold pressure.

FIG. 2 shows a typical prior art waste gate valve assembly 10 of the prior art. Shaft 20 of valve 30 is inserted into opening 40 in arm 50. Shaft 20 is prevented from sliding out of opening 40 by washer or other fastener 70. Arm 50 is actuated by the diaphragm assembly as described above in order to seat or unseat valve 30, thereby closing or opening the waste gate. Valve 30 is preferably not integrated with arm 50 to enable a small freedom of movement, which enables the valve to make a good seal, preventing leakage. Because shaft 20 and opening 40 comprise a circular cross section, valve 30 can rotate while disposed in arm 50. Because of high exhaust bypass volumes and velocities, and high exhaust temperatures (especially in gasoline engines), this rotation results in valve failure due to excessive wear.

This rotation can be limited to less than one rotation by the addition of anti-rotation pin 60 to valve 30. When valve 30 rotates, pin 60 eventually contacts arm 50, which prevents further rotation. However, some rotation still exists, which eventually causes valve wear and failure. Even if pin 60 is integrated with valve 30, and not attached via welding or a similar technique, pin 60 is not robust enough to withstand the turbocharger environment and eventually fails, resulting in unrestrained rotation and faster valve failure. Further, the existence of pin 60 causes thermomechanical distortion of valve 30 in the area of pin 60, which causes further damage to valve 30. Thus there is the need for a robust, cost-effective mechanism for preventing any rotation of a waste gate valve.

### BRIEF SUMMARY OF THE INVENTION

The present invention is a turbocharger waste gate assembly comprising a waste gate valve comprising an oblong shaft and an arm comprising an opening for receiving said shaft. The opening is preferably oblong. The shape of the opening is preferably substantially the same as the shape of the shaft. The shaft is preferably integrally formed with the valve during manufacture, although it optionally may be attached to the valve. The waste gate assembly preferably further comprises a fastener disposed on the shaft. The fastener, preferably comprising a washer, preferably prevents the shaft from sliding out of the opening.

The invention is also a method of preventing rotation of a turbocharger waste gate valve, the method comprising the steps of providing a waste gate valve comprising an oblong shaft, disposing the shaft into an opening of an arm, and disposing a fastener on the shaft. The opening is preferably oblong. The shape of the opening is preferably substantially the same as a shape of the shaft. The providing step preferably comprises integrally forming the shaft with the valve during manufacture. The method preferably further comprises the step of attaching the shaft to the valve. The fastener, preferably a washer, preferably prevents the shaft from sliding out of the opening.

A primary object of the present invention is to reduce failure rates of turbocharger waste gate valves.

Another object of the present invention is to prevent rotation of waste gate valves.

A primary advantage of the present invention is that the anti-rotation mechanism provided is robust enough to withstand the operating environment of a turbocharger.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a perspective semi-transparent view of a turbocharger showing a waste gate valve assembly;

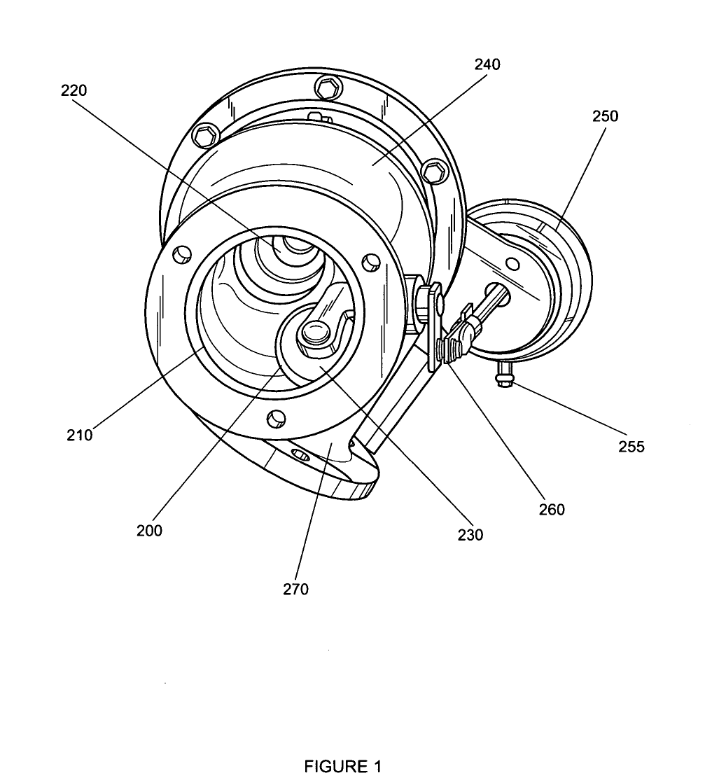

FIG. 2 depicts a prior art waste gate valve assembly; and

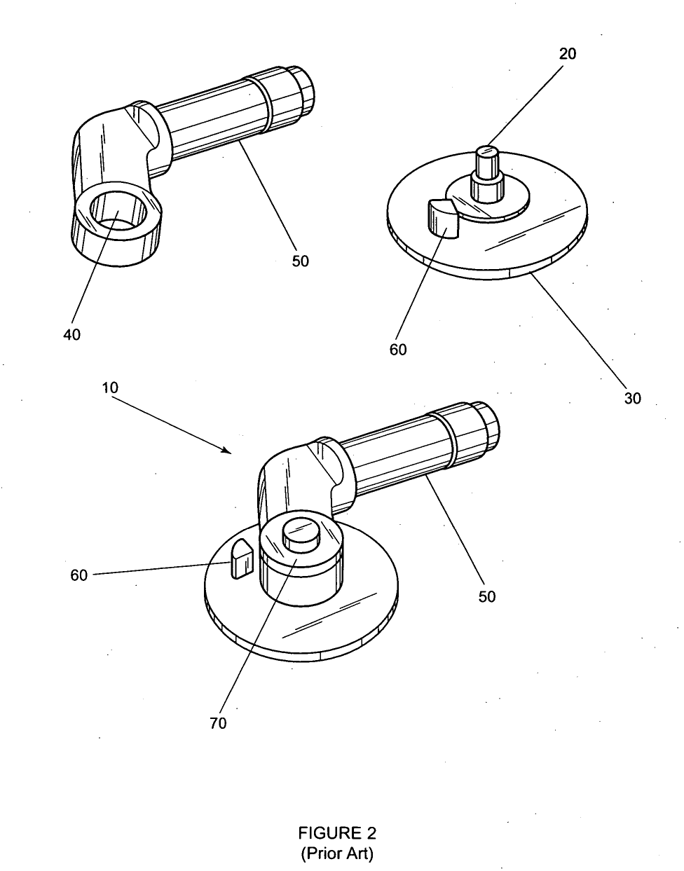

FIG. 3 depicts a waste gate valve assembly of the present invention.

### DETAILED DESCRIPTION OF THE INVENTION

The present invention is a non-rotating turbocharger waste gate valve. As used throughout the specification and claims, “oblong” means having any non-circular shape or cross section, such as oval, elliptical, elongate, square, and the like.

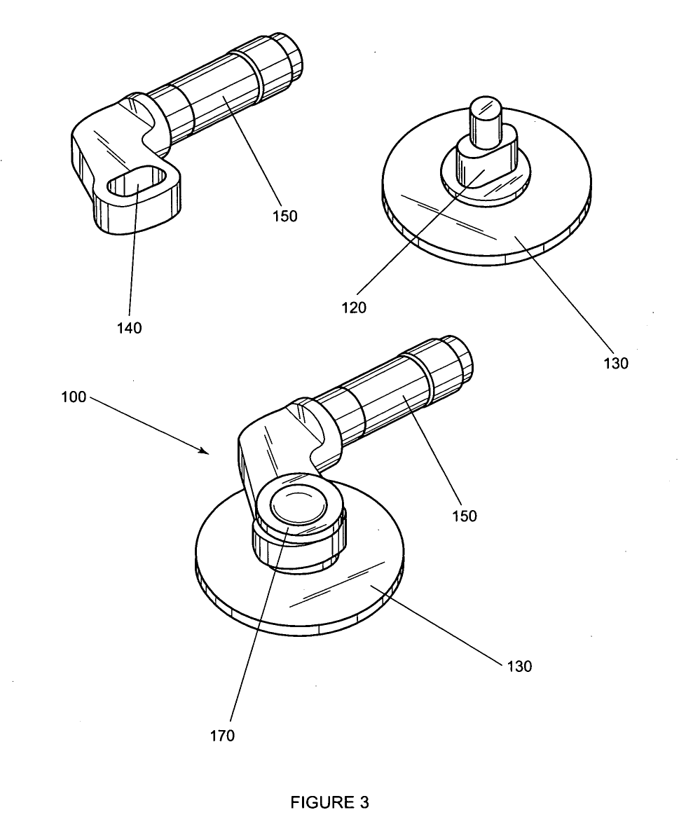

As shown in FIG. 3, waste gate valve assembly 100 of the present invention comprises valve 130 and arm 150. Valve 130 comprises shaft 120, which is inserted into opening 140 of arm 150. Shaft 120 is prevented from sliding out of opening 140 preferably by washer or other fastener 170. Rotation of valve 130 is prevented due to the oblong cross section of shaft 120. Opening 140 is also preferably oblong, further preventing rotation of shaft 120, especially under high loads. Opening 140 preferably comprises the same shape as shaft 120, so that shaft 120 fits snugly in opening 140. However, opening 140 optionally can comprise any shape which allows insertion of shaft 120 but prevents its rotation. The shape chosen for shaft 120 is preferably sufficiently elongated or non-circular to prevent rotation of valve 130 under high load conditions in the turbocharger. Shaft 120 is preferably integrated or formed with valve 130 during manufacture, such as through casting, although it may optionally be attached after manufacture, such as through welding or the like.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above, and of the corresponding applications, are hereby incorporated by reference.

What is claimed is:

1. A turbocharger waste gate assembly comprising:
a waste gate valve comprising an oblong shaft; and
an arm comprising an opening for receiving said shaft.

2. The waste gate assembly of claim 1 wherein said opening is oblong.

3. The waste gate assembly of claim 2 wherein a shape of said opening is substantially the same as a shape of said shaft.

4. The waste gate assembly of claim 1 wherein said shaft is integrally formed with said valve during manufacture.

5. The waste gate assembly of claim 1 wherein said shaft is permanently attached to said valve.

6. The waste gate assembly of claim 1 further comprising a fastener disposed on said shaft.

7. The waste gate assembly of claim 6 wherein said fastener prevents said shaft from sliding out of said opening.

8. The waste gate assembly of claim 6 wherein said fastener comprises a washer.

9. A method of preventing rotation of a turbocharger waste gate valve, the method comprising the steps of:
providing a waste gate valve comprising an oblong shaft;
disposing the shaft into an opening of an arm; and
disposing a fastener on the shaft.

10. The method of claim 9 wherein the opening is oblong.

11. The method of claim 9 wherein a shape of the opening is substantially the same as a shape of the shaft.

12. The method of claim 9 wherein the providing step comprises integrally forming the shaft with the valve during manufacture.

13. The method of claim 9 further comprising the step of attaching the shaft to the valve.

14. The method of claim 9 wherein the fastener prevents the shaft from sliding out of the opening.

15. The method of claim 9 wherein the fastener comprises a washer.
